(19) United States
(12) Patent Application Publication
(10) Pub. No.: US 2015/0136745 A1
(43) Pub. Date: May 21, 2015

(54) System and Method for Welding Using Super Capacitors

(71) Applicants: Aaron A. Astle, Payson, UT (US); Keyvan Vasefi, Payson, UT (US); Larin A. Dodgen, Payson, UT (US); Luke B. Peacock, Payson, UT (US); Preston E. Price, Payson, UT (US)

(72) Inventors: Aaron A. Astle, Payson, UT (US); Keyvan Vasefi, Payson, UT (US); Larin A. Dodgen, Payson, UT (US); Luke B. Peacock, Payson, UT (US); Preston E. Price, Payson, UT (US)

(21) Appl. No.: 14/084,575

(22) Filed: Nov. 19, 2013

(51) Int. Cl. B23K 9/10; G05F 3/16; B23K 9/09

(52) U.S. Cl. CPC B23K 9/1043; B23K 9/091; B23K 9/1081; G05F 3/16
USPC 219/130.21; 219/130.1; 219/130.51; 323/299

(57) ABSTRACT

Disclosed herein is a capacitive discharge welder that comprises a series of super capacitors (or ultra-capacitors) used as a power source. The capacitive discharge welder disclosed herein also comprises a dual function circuit that serves as an emergency stop circuit that is capable of redirecting or disconnecting the weld path in certain applications and situations and a drain circuit to drain a filter capacitor. The capacitive discharge welder disclosed herein is configured to use the super capacitor power supply in a direct discharge configuration as a CD welder. Additionally, the super capacitors are switched at frequency through a filter capacitor to produce a shaped DC welding waveform suitable for a wide variety of welding applications.

### BACKGROUND OF THE INVENTION

1. Technical Field

This invention relates to the field of welding and more particularly relates to enhanced capacitive discharge welding systems and methods.

2. Background Art

Capacitive discharge welders (CD welders), also called capacitive resistance or capacitor discharge spot welders, have been in use in a variety of industries for many years. These welding systems are used to produce quick burst of energy for controlled energy transfer into a specific weld spot. CD welders utilize capacitors, with an electrical circuit charging the energy in the capacitors to the desired level. The total capacitor energy is typically released in a very short time to the weld location through a welding transformer, producing the current required to make the weld.

CD welders have many advantages over other types of welder. For example, CD welders deliver a quick energy release for welding highly conductive metals such as copper. Another advantage of CD welders compared with typical AC welding machines is that CD welders have a higher power factor and balanced line loading when powered by a three-phase power supply and do not typically exhibit the “cycling” behavior that is common in AC machines. DC welders are relatively energy efficient and the weld energy is applied directly to the work piece without any significant heat loss. Similarly, CD welders are capable of concentrating the weld energy into relatively small weld zones while offering a repeatable energy release that is largely independent of supply line voltage fluctuations. Finally, CD welders are generally capable of very fine energy adjustments to allow greater control of the weld energy for precision welding applications.

However, CD welders are not without certain drawbacks and limitations that are directly related to the use of capacitors as a power source. Specifically, since a conventional capacitor has significant limitations in energy density, welding speed may be less than satisfactory for some applications. The power source that provides the energy to the capacitors needs time to raise the charge of the capacitors to the level at which they can supply the required energy necessary to make the weld. In many automated systems, poor and inconsistent welds can occur if welding is attempted before the capacitors are fully charged.

Another limitation of CD welders is that the welding current waveform is limited to the shape of a capacitor discharging with a high current level over a short period of time, typically in range of 10-60 milliseconds). This rapid release of energy over a short period of time can cause excessive weld splash and surface burning of the work piece. Additionally, conventional capacitors are relatively large, expensive, and have a relatively short service life, so most CD welders are low volt-ampere resistance welding machines. Accordingly, the applications for CD welders are somewhat limited and most CD welders are used in spot welding applications where short, highly focused, repeatable weld energy is highly valued.

Another type of welder that relies on capacitive energy storage is a linear DC welder. In this welding system, a bank of capacitors is rapidly cycled or switched on and off at high frequency and the output from the bank of capacitors is passed through one or more filter capacitors to provide for greater control of the output waveform generated by the typical linear DC welder. Linear DC welders are designed to provide a very smooth waveform in as little time as possible. Some linear DC welders may not require an external transformer, making it more convenient in certain applications. However, since the typical linear DC welder is also powered by standard capacitors, many of the disadvantages discussed above remain present in this system as well. For example, short weld times and lower repetition rate for repetitive welding applications.

Yet another type of welder is the high frequency (HF) welder. The typical HF welder has a three-phase power supply that is rectified to provide a DC output. The DC output is switched at a relatively high frequency (e.g., 2-25 kHz) to produce an AC current to the primary input of a transformer. The voltage is “stepped down” to increase the current up to 10,000 A or more. With this type of welder, the weld time is substantially longer than with other welders and the repetition rate for repetitive welding is significantly enhanced. However, as with the other welding methods discussed above, the advantages of the HF welder are offset by certain disadvantages. For example, HF welders require three phase power which can be costly and, in some environments, simply unavailable. Similarly, the higher currents generated by some HF welders may require a liquid cooled power supply, once again significantly driving up the cost of the unit.

### SUMMARY OF THE INVENTION

Disclosed herein is a capacitive discharge welder that comprises a series of super capacitors (or ultra-capacitors) used as a power source. The capacitive discharge welder disclosed herein also comprises a dual function circuit that serves as an emergency stop circuit that is capable of redirecting or disconnecting the weld path in certain applications and situations and a drain circuit to drain a filter capacitor. The capacitive discharge welder disclosed herein is configured to use the super capacitor power supply in a direct discharge configuration as a CD welder. Additionally, the super capacitors are switched at frequency through a filter capacitor to produce a shaped DC welding waveform suitable for a wide variety of welding applications.

### BRIEF DESCRIPTION OF THE FIGURES

The preferred embodiments of the present invention will hereinafter be described in conjunction with the appended drawings, wherein like designations denote like elements, and:

FIG. 1 is a diagram depicting the energy density and power density relationship for various types of power sources;

FIG. 2 is a schematic diagram of an ultra capacitor welder in accordance with a preferred embodiment of the present invention; and

FIG. 3 is a flow chart of a method of operating an emergency stop circuit used in conjunction with an ultra capacitor welder in accordance with a preferred embodiment of the present invention.

### DETAILED DESCRIPTION OF THE PREFERRED EMBODIMENTS

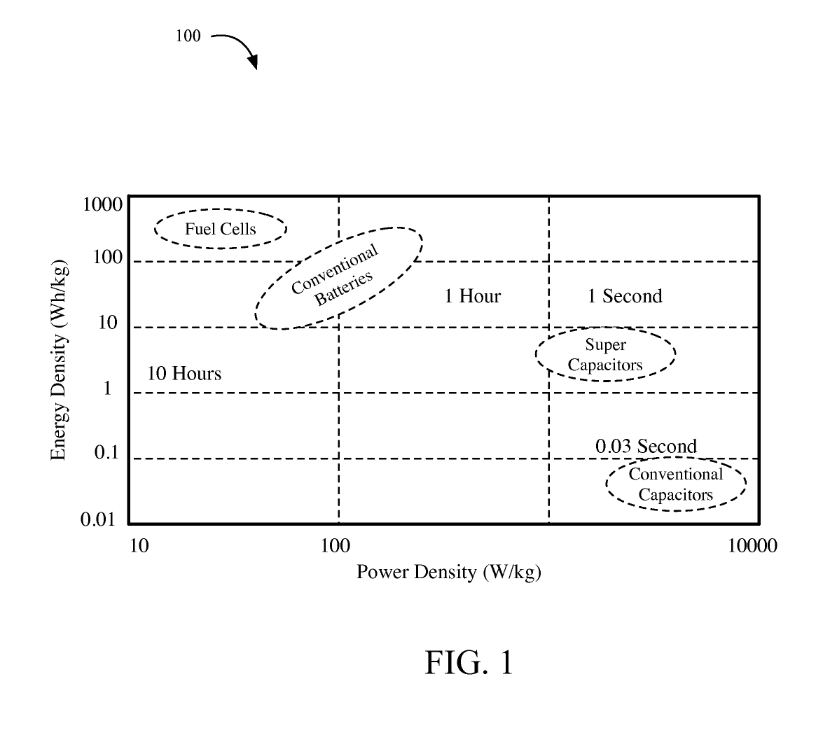

A “super capacitor,” also known as an electric double-layer capacitor or “ultra capacitor,” can be defined as an electrical component characterized by both double-layer capacitance and pseudocapacitance. Presently known super capacitors may have up to 10,000 times the capacitance of a conventional electrolytic capacitor and anywhere from 10 to 100 times the power density of a conventional battery. The relative ratio of power density and energy density for various power sources is illustrated in FIG. 1. As shown in FIG. 1, super capacitors are capable of delivering significantly higher performance for applications where higher levels of energy and power density are desirable.

The high energy density combined with high power density of super capacitors allows very large amounts of energy to be stored in a super capacitor with rapid charge and discharge cycles. A welder with a capacitive power source (e.g., a typical CD welder or Linear DC welder) that would typically be capable of storing 1,000 joules of energy using conventional capacitors could theoretically store in excess of 100,000 joules of energy if super capacitor technology were successfully deployed. This dramatic increase in energy storage capacity has the possibility of dramatically improving the performance of the welder.

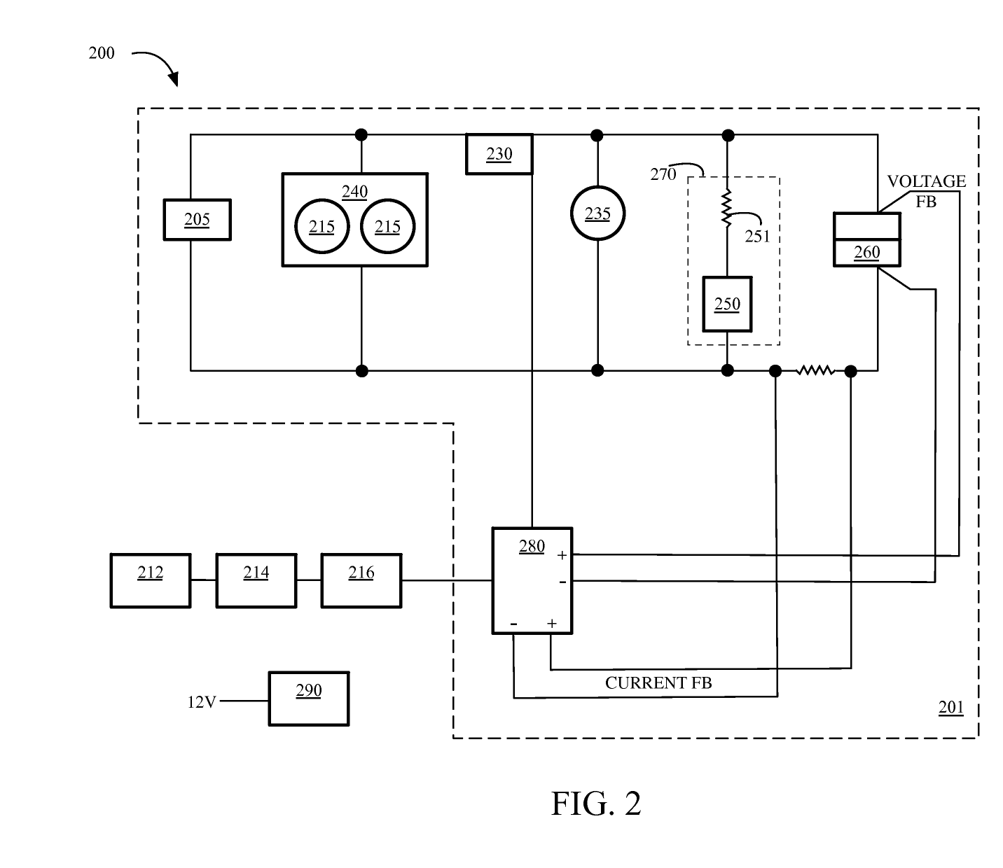

Referring now to FIG. 2, a schematic diagram for a preferred embodiment of an ultra capacitor welder 200 is depicted. Welder 200 includes several functions and features from previous welding systems while incorporating additional functions and features that are unique to the present invention. For example, welder 200 comprises: a power board 201; a user interface device 212; a central processing unit (CPU) or control circuit 214; a control board 216; an emergency stop control 290.

The most preferred embodiments of power board 201 used in conjunction with ultra capacitor welder 200 comprises: a power source 205; a super capacitor power supply 240; a weld switch 230; a power supply control circuit 280; a filter capacitor 235; and an emergency stop circuit 270. As shown in FIG. 2, emergency stop circuit 270 comprises an emergency switch 250 and a resistor 251.

User interface device 212 is a device used by an operator to communication with welder 200 and to control the operation of welder 200. While user interface device 212 may be any one of several devices, the most preferred embodiments of the present invention will incorporate a tablet computer such as an iPad® or similar device (e.g., Android tablet, Windows® Surface® tablet, etc.). There are a number of other easy-to-use touch interfaces devices as well and all of these devices may be used to provide a graphical user interface for enhancing the welding process using welder 200. The most preferred embodiments of the present invention will most preferably comprise a user interface device 212 configured to communicate via a wired or wireless connection with control board 216. While many communication protocols may be used, the most preferred embodiments of the present invention use Universal Serial Bus (“USB”) communications device class (“CDC”) to send bulk data transfers from user interface device 212 to control board 216.

Central processing unit (CPU) or control circuit 214; represents a digital microprocessor or micro controller, microcontroller (“MCU”) or similar device. CPU 214 receives the USB signal from user interface device 212 and communicates with control board 216 to control the welding operation of welder 200. CPU 214 also controls universal asynchronous receive/transmit (“UART”) communication to a programmable logic controller (“PLC”) for data acquisition from feedback at the weld point, and other signals to control the welding parameters and welding operation for welder 212.

Control board 216 is configured to communication with user interface device 212 and power supply control 280. Control board 216 receives the USB signals from user interface device 212 via CPU/control circuit 214. The most preferred embodiments of the present invention may also have one or more temperature monitors on the ultra capacitors, charge MOSFETs, weld MOSFETs, weld out positive terminal, weld out negative terminal. All of these temperatures will be acquired by the same MCU. This MCU operates at 70MIPS and provides the speed we need to adjust weld parameters accurately.

Control board 216 also includes a plurality of opto-isolators to reduce or eliminate large voltage or current spikes that may adversely effect the operation of the MCU. All signals that control the charging of the capacitors, welding, bleeding and emergency bleed circuit run through these opto-isolators. Essentially, any signal that controls a component that could potentially put a dangerous voltage on the MCU has been routed through an opto-isolator.

As shown in FIG. 2, a current feedback and voltage feedback circuit is also used to monitor the welding process. Voltage feedback and current feedback are monitored at a designated rate (typically in the range of 10 kHz-25 kHz, or more) during the welding cycle. The current feedback and voltage feedback is supplied to control board 216 and, in turn, to power supply control 280. As the welder receives the voltage and current feedback, it makes adjustments during the weld to stay within the input parameters supplied by the user via user interface device 212.

Power source 205 is any suitable power source that may be deployed to energize super capacitor power supply 240 and is most preferably a standard 110V/220V power supply. The most preferred embodiments of the present invention comprise a constant current limited power supply.

Super capacitor power supply 240 comprises at least one super capacitor 215 that are used as a power source within welder 200 where super capacitors 215 are repeatedly cycled or switched on and off to the weld path via weld switch 230 at a controlled rate with the output being filtered by filter capacitor 235 to optimize weld precision. In the most preferred embodiments of the present invention, the actual number of super capacitors 215 will be determined by the specific requirements of the welding application. Similarly, super capacitors 215 may be configured and electrically connected in a series or parallel fashion, as needed to meet the power and output requirements for the application. It will understood by those skilled in the art that the circuit designs described herein are illustrative in nature and no limitation as to the specific number or arrangement of capacitors 215 is intended hereby.

When using super capacitors 215 as the main power source for a weld, it is necessary to provide a way of switching these capacitors to and from the weld path. Using super capacitors 215, therefore, requires intermediate circuitry with a high enough current and voltage rating to be able to manage the maximum current and voltage generated by super capacitor power supply 240 while maintaining the capability to rapidly switch super capacitor power supply 240 on and off of the weld path at high frequencies if welder 200 was configured as a filtered output DC type system.

While the enhanced capabilities of super capacitor power supply 240 are significant, there are additional considerations that are important to address with this unique design. For example, the significantly higher levels of energy stored in super capacitor power supply 240 significantly increases the possible danger if the welder failed and an unintended discharge of the energy resulted. Specifically, given the high power storage capabilities associated with super capacitor power supply 240, if the weld circuit were to fail in a closed condition, which is the most likely failure scenario, a very large amount of stored energy may be inadvertently discharged from welder 200 in an undesirable fashion.

In order to eliminate or reduce this possibility, the most preferred embodiments of the present invention comprise an emergency stop circuit. The emergency stop circuit is configured to remove the current from the circuit until the ultra capacitor bank is to a safe voltage. This circuit will also turn off the power supply used to charge the ultra capacitor bank, and will enhance the operational safety for a super capacitor based welder. Emergency stop circuit 270 is configured to redirect energy internally (e.g., in parallel) or, in an alternative preferred embodiment of the present invention, the emergency stop circuit may be arranged in a series configuration so as to interrupt the welding circuit in a failure mode. Finally, in at least one preferred embodiment of the present invention, the emergency stop circuit may be arranged in a hybrid fashion that is a combination of both series and parallel configurations.

Those skilled in the art recognize that the use of an emergency stop circuit 270 is not needed with conventional capacitive discharge welders since conventional capacitors are incapable of storing enough energy to maintain a long enough weld to cause the degree of damage a super capacitor based welder may cause. With a prior art linear DC welder, simply disconnecting the power supply from the capacitors is all that is needed to provide for most emergency situations. Although a part may be ruined at the weld point, a catastrophic failure will not cause significant damage outside of the typical linear DC welder because any residual energy is quickly dissipated before any significant damage can occur.

However, with the introduction of super capacitors 215 as a power source for welder 200, an emergency stop circuit 270 that is configured to safely mitigate potential inadvertent electrical discharges in a failure scenario is highly desirable for safe operation of welder 200. Emergency stop circuit 270 is most preferably configured to redirect the stored energy from super capacitors 215 internally (parallel) or be placed in series to break the circuit in a failure mode, or a combination of both.

Unlike conventional CD welders, simply disconnecting power supply 205 from super capacitor power supply 240 is not enough. Once power supply 205 is disconnected, there is still up to 75,000 J (Joules) of energy (or more) stored in super capacitors 215 of super capacitor power supply 240. If the catastrophic failure is in the “switch” portion of the circuit shown in FIG. 2, which is the most probable situation for a failure, super capacitors 215 will continue to discharge at the weld point. The discharge of the energy from super capacitors 215 may cause melting of electrodes, significant damage to the weld piece, or even burns to the operator of welder 200 from molten metal coming from the weld point. This makes it desirable to have an emergency stop circuit that can either completely disconnect the weld path, or an emergency stop circuit that can redirect the majority of the weld current to an isolated, safe location.

Given the undesirable consequences associated with the inadvertent discharge of energy from super capacitors 215, emergency stop circuit 270 is included in the most preferred embodiments of the present invention, in at least one of two ways, as described above. One preferred embodiment of the present invention comprises an emergency stop circuit 270 that is configured to redirect the weld current, through one or more emergency switches 250, to a predefined path to a resistor 255, thereby dissipating the stored energy from super capacitors 215 within welder 200.

Switch 250 is most preferably a MOSFET switch and is controlled by emergency stop circuit 270, Switch 250 serves to transfer the bulk of the energy from the weld point to resistor 251, and ensure the availability of an enclosed location where an internal resistance would be rated to quickly dissipate any energy stored within welder 200. In the most preferred embodiments of the present invention, resistor 251 is on the order of 2 milliohms. This relatively small resistance models the probable resistance at a typical weld spot but the actual resistance of resistor 251 may vary and will be adjusted for specific welding applications. The resistance provided by resistor 251 will most preferably be configured to cut the current at the weld point at least in half. In this manner, two paths current dissipation paths are provided, allowing the current generated by super capacitors 215 to be drained much more quickly. Rather than a 20 second discharge from super capacitors 215, the current discharge time can be reduced to 6-10 seconds. This will significantly reduce the possibility of generating molten metal at the weld output and make welder 200 safer to operate and service.

The second form of emergency stop circuit comprises a circuit with a mechanical or solid-state relay with sufficient voltage and current ratings to be able to switch a maximum weld current from super capacitors 215. This would enable super capacitors 215 to maintain their charge, and rather than redirecting the energy from super capacitors 215 into the form of heat within welder 200, the emergency stop circuit would completely isolate super capacitors 215 from any discharge point so as to stop any current transfer that could potentially cause damage in an emergency situation. It should be noted that the implementation of an emergency stop circuit using a disconnection or isolation approach may be implemented within or without a fluid of high dielectric constant.

While the isolation of the weld path is certainly a viable alternative approach for implementing an emergency stop circuit, there are several disadvantages to this approach. First, the inclusion of a mechanical switch or relay in line with the weld path introduces undesirable resistance which tends to limit the maximum current welder 200 can produce. Second, given the relatively high level of current being generated, a mechanical switch may cause arcing within the relay and destroy the relay, possibly introducing another failure point.

Accordingly, the redirection of the current from super capacitors 215 to resistor 251 is generally considered to be more preferable than simply disconnecting super capacitors 215 from the weld path and leaving the energy stored in super capacitors 215 in an emergency situation. The redirection approach to implementing emergency stop circuit 270 is designed to completely drain super capacitors 215 of all stored energy, using resistor 251. Emergency stop circuit 270 would also be able to function as a capacitor discharge circuit when no load is connected to the external weld path. This circuit may also be used to drain filter capacitor 235 if necessary, should filter capacitor 235 be energized between weld cycles so as to prevent damage to components when contact is made with the work piece.

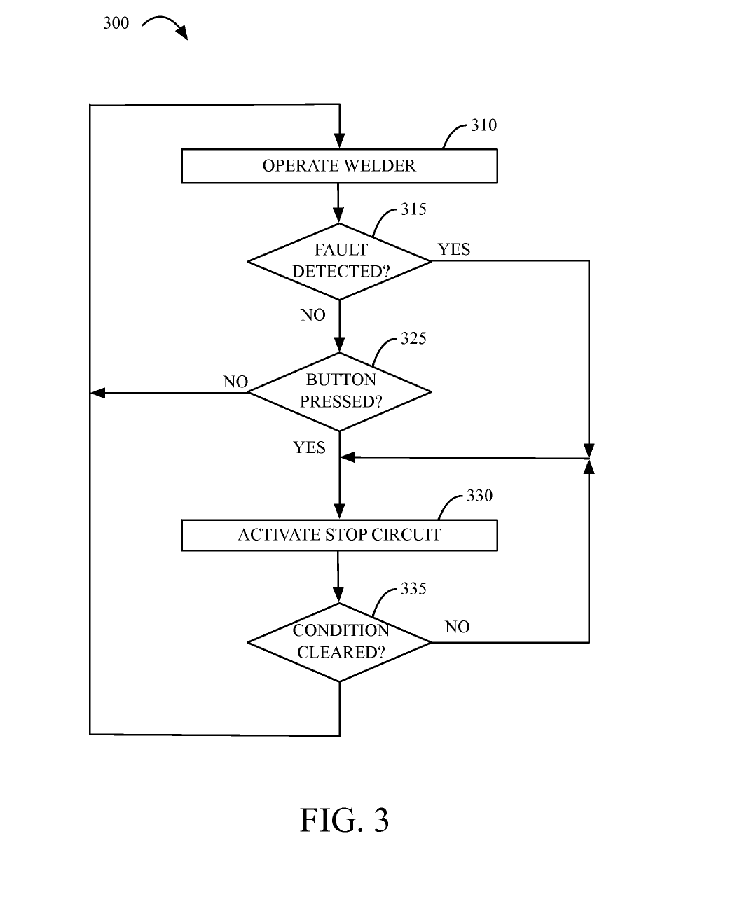

Referring now to FIG. 3, a method 300 for activating emergency stop circuit 270 of FIG. 2 is depicted. It is important to note that, regardless of the specific nature of the approach used to implement emergency stop circuit 270, there are at least two different ways that emergency stop circuit 270 may be triggered. As shown in FIG. 3, the welder will be in operational mode (step 310) until one of two conditions is detected. First, the CPU may detect a fault condition (step 315=“YES”), for example a fault at the output of the welder. In this case, emergency stop circuit will be activated (step 330). Alternatively, the operator of the welder may detect a fault or other condition that constitutes an emergency and will press an external “stop” button or other mechanism (step 325=“YES”) and emergency stop circuit will be activated (step 330). In either case, once the condition has been cleared, the operation of the welder can continue (step 310). Additionally, as long as no fault is detected (step 315=“NO”) and the button is not pressed by the operator (step 325=“NO”) then the welder will continue to be operational (step 310).

Additionally, it should be noted that emergency stop circuit 270 of FIG. 2 is also useful for another purpose. After completion of a weld, it is possible that filter capacitor 235 may, in some circumstances, retain enough of a residual charge to cause a slight arc upon contact of the weld head with the weld piece. This unintended arcing may seriously damage or destroy the weld piece. In order to drain filter capacitor 235 after a weld, emergency stop circuit may be activated, thereby preventing any unintentional arcing at the weld head.

As described herein, the various preferred embodiments of the present invention provide for significant advancement over the current options for capacitive discharge welding applications. Specifically, the preferred embodiments of the present invention provide for a linear DC welder that uses a standard 110V/220V power supply instead of the more costly and less available than a three phase power supply.

Additionally, the use of super capacitors provides a welder with significantly longer weld times than offered by a typical HF welder. With consistent weld times in the range of 3 seconds, welding operations can be completed with less down time for various applications that require such weld times.

Further, the super capacitor welder of the present invention provides for a higher repetition rate, similar to the repetition rate offered by an HF welder while provide a much more convenient form factor since no power transformer is required as with an HF welder. Finally, the super capacitor welder of the present invention is capable of performing high precision welds in the same fashion as a typical linear DC welder.

From the foregoing description, it should be appreciated that the various preferred embodiments of the present invention disclosed herein presents significant benefits that would be apparent to one skilled in the art. For example, those skilled in the art will recognize that the functions and operations of user interface device 212, CPU 214, control board 216, and emergency stop circuit 270 of FIG. 2 may be implemented in a number of different ways. A single personal computer, configured with the appropriate hardware and software, could be used to control power board 201 and welder 200.

Furthermore, while multiple embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. An apparatus comprising:
a power supply;
at least one super capacitor coupled to the power supply, the power supply energizing the at least one super capacitor, the at least one super capacitor generating an electrical current;
an emergency stop circuit coupled to the at least one super capacitor;
a switch coupled to the emergency stop circuit; and
a CPU coupled to the switch, the CPU sending a signal to the switch in response to an emergency signal, the switch redirecting the electrical current generated by the at least one super capacitor to the emergency stop circuit.

2. The apparatus of claim 1 further comprising a user interface device coupled to the CPU, the user interface device displaying a graphical user interface.

3. The apparatus of claim 1 wherein the emergency stop circuit comprises:
an emergency switch; and
a resistor.

4. The apparatus of claim 1 wherein the at least one super capacitor comprises a bank of super capacitors.

5. The apparatus of claim 1 further comprising a filter capacitor, the filter capacitor creating a filtered output welding waveform.

6. The apparatus of claim 1 further comprising a control board coupled to the CPU, the control board receiving data transferred from the user interface device.

7. The apparatus of claim 1 further comprising a power supply control circuit coupled to the CPU, the power supply control circuit controlling the electrical current generated by the at least one super capacitor.

8. The apparatus of claim 1 further comprising:
a control board coupled to the CPU, the control board receiving data transferred from the user interface device; and
a power supply control circuit coupled to the CPU, the power supply control circuit controlling the electrical current generated by the at least one super capacitor.

9. The apparatus of claim 1 further comprising a weld switch, the weld switch repeatedly switching the electrical current generated by the at least one super capacitor on and off a weld path at a controlled rate.

10. The apparatus of claim 1 wherein the at least one super capacitor comprises a bank of super capacitors and further comprising:
a filter capacitor, the filter capacitor creating a filtered output current waveform;
a control board coupled to the CPU, the control board receiving data transferred from the user interface device; and
a power supply control circuit coupled to the CPU, the power supply control circuit controlling the electrical current generated by the bank of super capacitors.

11. A welder, the welder comprising:
a power supply;
a bank of super capacitors coupled to the power supply, the power supply energizing the bank of super capacitors, the bank of super capacitors generating an electrical current;
an emergency stop circuit coupled to the bank of super capacitors;
a switch coupled to the emergency stop circuit;
a CPU coupled to the switch, the CPU sending a signal to the switch in response to an emergency signal, the switch redirecting the electrical current generated by the bank of super capacitors to a resistive load;
a user interface device coupled to the CPU, the user interface device displaying a graphical user interface;
a filter capacitor coupled to the bank of super capacitors, the filter capacitor creating a filtered output current waveform from the electrical current generated by the bank of super capacitors;
a weld switch, the weld switch repeatedly switching the electrical current generated by the at least one super capacitor on and off a weld path at a controlled rate;
a control board coupled to the CPU, the control board receiving data transferred from the user interface device; and
a power supply control circuit coupled to the CPU, the power supply control circuit controlling the electrical current generated by the bank of super capacitors.

12. A method comprising the steps of:
monitoring the operational performance of a capacitive discharge welder, the capacitive discharge welder generating an electrical current suitable for welding operations, the capacitive discharge welder comprising:
an AC power supply;
a super capacitor power source coupled to the AC power supply, the super capacitor power source storing electrical energy; and
an emergency stop circuit;
activating the emergency stop circuit upon the detection of a fault or an emergency condition; and
diverting the electrical energy stored in the super capacitor power source to a resistive load.

13. The method of claim 12 wherein the step of activating the emergency stop circuit upon the detection of a fault or an emergency condition comprises the step of detecting the fault or the emergency condition by a CPU.

14. The method of claim 12 wherein the step of activating the emergency stop circuit upon the detection of a fault or an emergency condition comprises:
detecting the fault or the emergency condition by a human operator; and
pressing a switch to activate the emergency stop circuit.

15. The method of claim 12 wherein the capacitive discharge welder further comprises a CPU coupled to the super capacitor power source, the CPU sending a signal to a switch in response to an emergency signal, the switch redirecting the electrical current generated by the super capacitor power source to a resistive load.

16. The method of claim 12 wherein the capacitive discharge welder further comprises a user interface device, the user interface device displaying a graphical user interface to a human operator.

17. The method of claim 12 wherein the capacitive discharge welder further comprises:
a filter capacitor coupled to the super capacitor power source, the filter capacitor creating a filtered output current waveform from an electrical current generated by the super capacitor power source; and
a weld switch, the weld switch super repeatedly switching the electrical current generated by the super capacitor power source on and off a weld path at a controlled rate.

18. The method of claim 12 wherein the capacitive discharge welder further comprises a power supply control circuit, the power supply control circuit controlling the electrical current generated by the super capacitor power source.

19. The method of claim 12 wherein the capacitive discharge welder further comprises:
a user interface device, the user interface device displaying a graphical user interface to a human operator;
a filter capacitor coupled to the super capacitor power source, the filter capacitor creating a filtered output current waveform from an electrical current generated by the super capacitor power source;
a weld switch, the weld switch repeatedly switching the electrical current generated by the super capacitor power source on and off a weld path at a controlled rate; and
a power supply control circuit, the power supply control circuit controlling the electrical current generated by the super capacitor power source.

20. The method of claim 12 further comprising the step of activating the emergency stop circuit to drain a filter capacitor.
